(19) United States
(12) Patent Application Publication
(10) Pub. No.: US 2013/0332300 A1
(43) Pub. Date: Dec. 12, 2013

(54) Auction System and Method

(71) Applicant: Pure Penny, LLC, Bardstown, KY (US)

(72) Inventor: Richard A. Hornick, Bardstown, KY (US)

(73) Assignee: Pure Penny, LLC, Bardstown, KY (US)

(21) Appl. No.: 13/888,789

(22) Filed: May 7, 2013

Related U.S. Application Data
(60) Provisional application No. 61/644,298, filed on May 8, 2012.

(51) Int. Cl. G06Q 30/08

(52) U.S. Cl. CPC G06Q 30/08
USPC 705/26.3

(57) ABSTRACT

An auction system and method is provided comprising an auction server, a database communicating with the auction server for storing a set of auction cards and an accounting server for creating and maintaining a set of member accounts, a set of permit tag accounts and a set of coupon accounts. The auction card comprises an auction type, a current value, a bid device, a timer device, an auction item description and a suggested retail price. The auction server executes an auction for an auction item, accepting a set of bids, decrementing a bid value from the set of member accounts, determining a winning bidder of the auction, determining a set of losing bidders of the auction. If the auction item is cash, designating a cash value in the set of member accounts. A set of redeemable coupons are distributed to the set of losing bidders.

### CROSS-REFERENCE TO RELATED APPLICATION

This application claims priority benefit from U.S. Provisional Patent Application No. 61/644,298 filed May 8, 2012.

### FIELD OF THE INVENTION

The present invention relates generally to the delivery of online web based auction services, particularly, penny auctions.

### BACKGROUND OF THE INVENTION

A penny auction, also known as a bidding fee auction, is a type of all-pay auction in which all participants must pay a non-refundable fee per bid to place a set of small incremental bids. The auction ends after a period of time, typically ten to twenty seconds, without new bids; the last participant to have placed a bid wins the item and also pays the final bid price, which may be significantly lower than the retail price of the item. The auctioneer collects income in two ways: the fees for each bid and the payment for the winning bid, which can be significantly more than the value of the item. Such auctions are typically held over the Internet, rather than in person.

Participants pay a non-refundable fee to purchase bids. Each of the bids increases the price of the item by a small amount known as the bidding increment, such as one penny (0.01 USD), which can extend the time of the auction by a few seconds. Bid prices vary by site and quantity purchased at a time, but are generally some multiple of the bidding increment. The auctioneer receives the money paid for each bid, plus the final price of the item.

In game theory an all-pay auction, is an auction in which every bidder must pay regardless of whether he wins the prize, which is awarded to the highest bidder as in a conventional auction. The most straightforward form of an all-pay auction is a Tullock lottery, in which everyone submits a bid but both the losers and the winners pay their submitted bids. A conventional raffle can also be seen as a related process, since all raffle ticket-holders have paid for a raffle ticket but only one wins the prize.

U.S. Patent Application Publication No. 2002/0077890 to LaPointe, et al. discloses collecting and redeeming reward points by bidding for selected opinions through purchases and auctions for reward items (e.g., services, products, discounts, and the like) utilizing the list of interactive options which includes reward auction, reward redemption, point balance transfers, and further includes the step of deducting a bid fee from the user's point balance.

U.S. Patent Application Publication No. 2003/0216959 to Vitti discloses a system and method for rewarding participation in an auction. When an auction is complete, the high bidder wins the auction and a central database records an award to non-winning bidders as an incentive for future participation in other auctions.

International Patent Publication WO 2009/009455 to Hamman, et al. discloses a method of conducting an online auction using chance based incentives, enabling a seller to select a chance based incentive to encourage bidders to bid on a product.

U.S. Pat. No. 7,152,042 to Arkes discloses administering an on-line auction by retaining collected credit point totals for authorized participants.

U.S. Patent Application Publication No. 2012/0084169 to Adair, et al. discloses an online auction over a network server system for multiple items and U.S. Patent Application Publication No. 2012/0084170 also to Adair, et al. discloses accumulating incentive points for participating in online auctions.

U.S. Pat. No. 7,461,022 to Churchill, et al. discloses an online auction system with a separate auction server and account database for processing bids.

U.S. Pat. No. 7,702,540 to Woolston discloses online auctions and sales of collectable goods with posting terminals which display images and interact with central marketing and selling systems.

The prior art has failed to develop a rich experience with bidders, owners and sponsors of online auctions, particularly penny auctions, that keeps them engaged with the auction website.

### SUMMARY OF THE INVENTION

The present disclosure describes an auction system having an auction server, a database server and an accounting server in communication through a communications network. The auction server controls a set of auctions. The database server stores a set of auction cards which include a set of information for the set of auctions. The accounting server communicates with the auction server to receive deposits into a set of client accounts and to distribute proceeds from the set of auctions into the set of client accounts.

Auction users include bidders for auction items in the form of the auction cards, owners of auction items and sponsors of auction items. The auction server is configured to authenticate and respond to a set of auction bidder client systems, an auction owner client system and an auction sponsor client system. The auction server is further configured to manage sales of the set of auction cards by displaying the set of auction cards on a set of web pages and responding to the set of auction bidder client systems through a web service.

Bids are activated by depositing money into an account. The price of a bid is deducted from the account whenever a bid is placed in an auction. Money can be won and deposited into the account. The account designates two methods to withdraw money. “Bidding Money” is only withdrawn for bids while bidding in an auction. “Take Home Money” may be withdrawn and sent to the member.

The winner of any auction becomes the “Owner” of the “Asset” which is the auction item described in the auction card. The “Asset” may be a physical item, an intangible item, or a method to earn money. Auction cards have pre-programmed methods referred to as “Auction Types”.

As with winners, losers of an auction also become the owner of an asset which may also be a physical item, intangible item, or a method of earning money. An example is “Coupon Money”, which is money deposited into a member's coupon account.

The system and methods of auctioning assets to enhance the member's experience and to share proceeds of the site become parametric and are further described in the detailed description that follows.

### BRIEF DESCRIPTION OF THE DRAWINGS

FIG. 1 is a block diagram of a preferred embodiment of an auction system.

FIG. 2 is a block diagram showing the auction pages and an auction card for an auction system.

FIG. 3 is a block diagram showing member interaction with an auction card in an auction system.

FIG. 4A is a flow diagram for setting up an auction.

FIG. 4B is a flow diagram for executing an auction.

FIG. 5 is a flow diagram of a method for processing a “Non-Resale” auction card that results in the distribution of an item.

FIG. 6 is a flow diagram of a method for processing an auction card that results in the deposit of earnings in a member account.

FIG. 7 is a block diagram showing the features of a “Take Home Money” auction card and two “Bids Money” auction cards.

FIG. 8 is a flow diagram of a method for processing an auction for a permit tag.

FIG. 9 is a flow diagram of a method for processing a “Bids Back” auction card that returns bidding money spent on bids to an owner.

FIG. 10 is a flow diagram of a method for reselling a “Resale” auction card or shipping a resale item won in the “Resale” auction card.

FIG. 11 is a flow diagram of a method for processing an auction card that allows an owner to redeem coupons.

FIG. 12 is a flow diagram of a method for processing a “Shares” auction card and to distribute shares earnings to a shares owner.

FIG. 13 is a flow diagram of a 40-day rule method for responding to auction events.

FIG. 14 is a time sequence diagram of an auction card and a placeholder card.

FIG. 15 is a time sequence diagram depicting a method for generating and displaying a “Pop Card” auction card.

FIG. 16 is a flow diagram of a method to distribute auction coupons and sponsor coupons.

### DETAILED DESCRIPTION

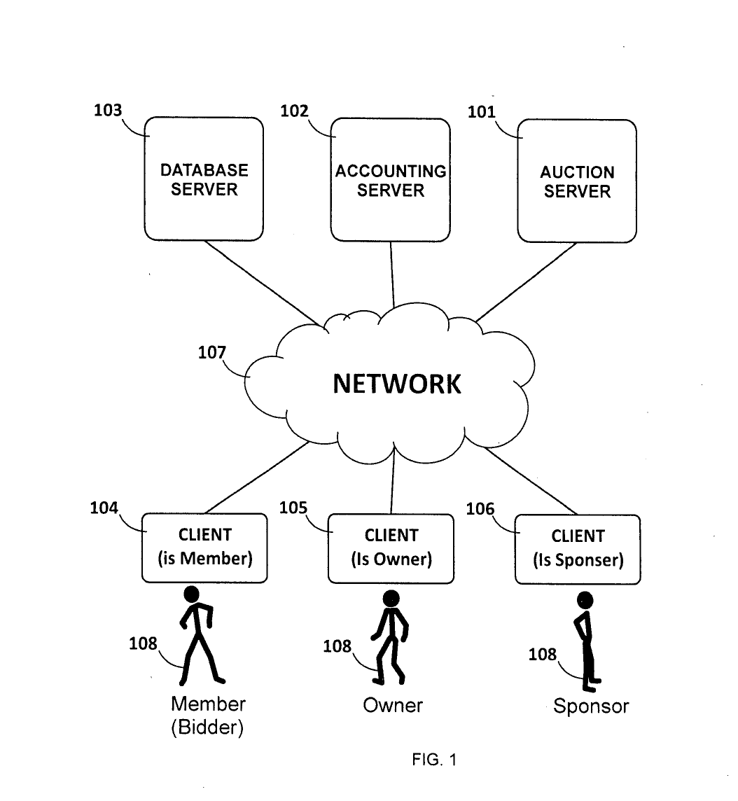

Referring to FIG. 1, the system and methods of the present invention are implemented using an auction server 101, an accounting server 102 and a database server 103 connected to a network 107. Auction server 101 includes a host computer system having at least one host computer server with at least one processor for executing the methods and auction processes embodied within a set of programmed instructions. The set of programmed instructions are stored in a host electronic memory and in a host digital storage media contained within the host computer server. The host computer system is connected to network 107 and operates a web hosting application utilizing a web server, such as an Apache web server, capable of serving a set of web pages to a set of client systems, client system 104, client system 105 and client system 106 are also connected to the network 107. The primary function of the host computer system is to manage and control auctions.

Network 107 includes local area networks and wide area networks, such as the Internet, transporting packetized data between the various servers and clients in the system.

Accounting server 102 is connected by network 107 to auction server 101 and interacts with auction server 101 to manage client accounts such as member money accounts, permit accounts, coupon accounts and share accounts in real time. The set of accounting instructions implementing a set of accounting processes on the accounting server are stored in an account server electronic memory and in an account server digital storage media contained within the accounting server. The programmable instructions are executed by an account server processor to manage the client accounts.

A database server 103 is connected by network 107 with auction server 101 and accounting server 102. Database server 103 implements a relational database residing in a database electronic memory and database digital storage media and is executed by a database processor. Furthermore, it is understood that database server 103 is electronically accessible by the executed methods of the preferred embodiment including auction processes and accounting processes. The database server stores auction card information, real time auction information and user account information.

Many different database server and accounting server configurations are possible. In one embodiment, database server 103, auction server 101 and accounting server 102 are hosted on separate physical machines which can be located at separate physical locations. In another embodiment, database server 103, auction server 101 and accounting server 102 are hosted on a single physical computer system. Other embodiments for the servers are conceivable. For example, the auction server can include a plurality of physical host machines connected by the network.

A client system is a computer device with memory, data storage media and a CPU executing an operating system and a web browser connected to the Internet, and further including a display device, keyboard device and a pointing device for interacting with a set of users 108 comprising an auction bidder, a share owner and a sponsor. In FIG. 1, three exemplary client systems are shown: client system 104 is operated by the auction bidder to bid on auctions, client system 105 is operated by the share owner of a good or service currently in an auction or previously in an auction, client system 106 is operated by the sponsor of goods and services sold in auctions. Many possibilities for client systems exist, for example a client system may operate simultaneously for auction bidding and share owning. The auction bidder, share owner and sponsor are also members of the auction, their respective client systems being authenticated with the auction server.

It is contemplated that the client system and host computer system are stand alone computers. In another embodiment, the client system is a handheld communication device configured to maintain a secure communication session with the host computer server and configured to receive and display web pages from the internet. The host computer server can be configured to detect the type of client system and appropriately display auction webpages in the most suitable format (size, tabs, widgets etc) to optimize the client experience.

In yet other embodiments, the client system is a handheld communication device, such as a smart phone, configured with a handheld application executed locally by the client system; the handheld communication device, for example, being an Android OS device or an Apple IOS device. The host computer server is configured to interact with the handheld application to generate and service the various auction tools and widgets.

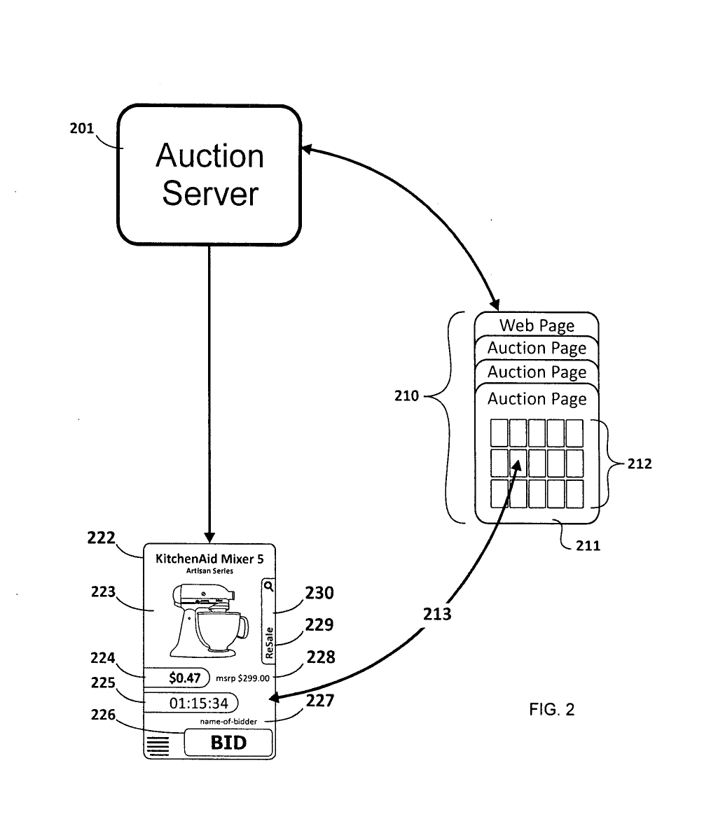

Referring to FIG. 2, auction server 201 generates a set of auction pages 210 including auction page 211. Auction page 211 includes a set of auction cards 212 in a set of placeholder positions on auction page 211. An example auction card 213, from the set of auction cards 212, is shown for a kitchen mixer. However the set of auction cards can represent many goods, services and special auction functions. Additionally, the set of placeholder positions can be used to display placeholder activities before and after displaying an auction card.

A single “auction card” is a set of detailed information about a unique auction of a unique good, service or auction function that is represented as a container in the auction server and displayable in a predefined graphical format. The detailed information includes “static” information and “dynamic” information stored in the database server. The “static” information includes, for example, display asset item title 222, asset item image 223, bid button 226, asset item manufacturer's suggested retail value 228, “peek bar” 230 which identifies asset item auction type 229. “Dynamic” information includes, for example, the current bid price 224, the current auction timer countdown value 225, and the current or most recent bidder name 227.

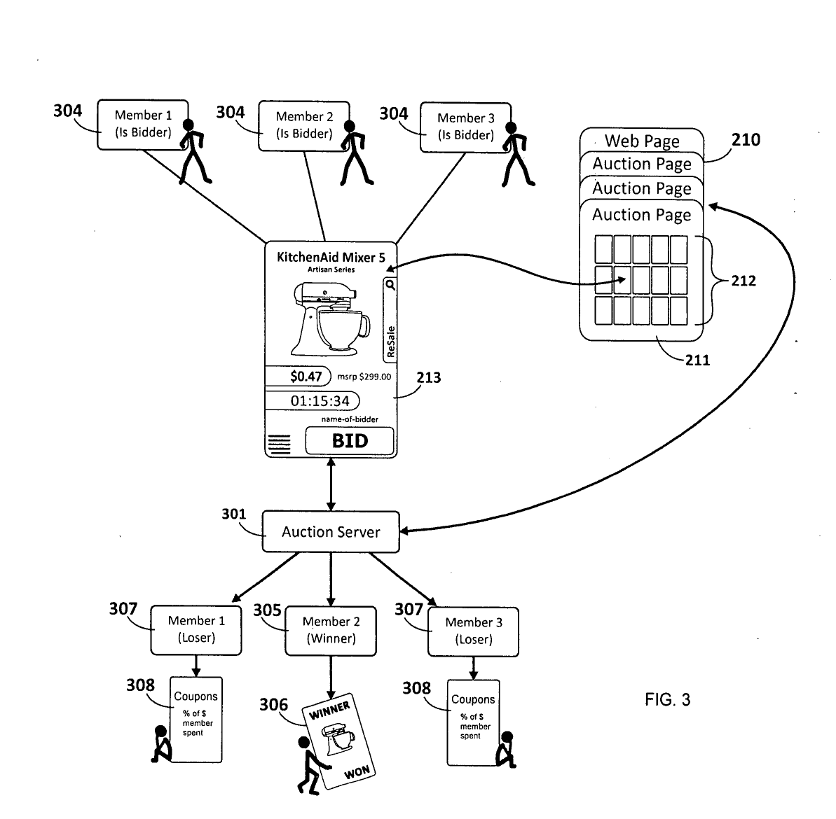

Referring to FIG. 3, during and after an auction event, auction server 301 connects a set of bidders 304 to interact with an auction card 313 displayed in a placeholder position 314 on an auction page 311. A set of auction cards 312 is also displayed on auction page 311 and in the set of auction pages 310. Auction server 301 is configured to receive and track a set of bids for auction card 313 with the help of the accounting server. Based on the set of bids, auction server 301 is configured to determine a winning bidder 305 and a set of losing bidders 307. Accordingly, a won item 306 is associated to the winning bidder 305 and a losing benefit, such as a set of coupons 308, is associated to the set of losing bidders 307.

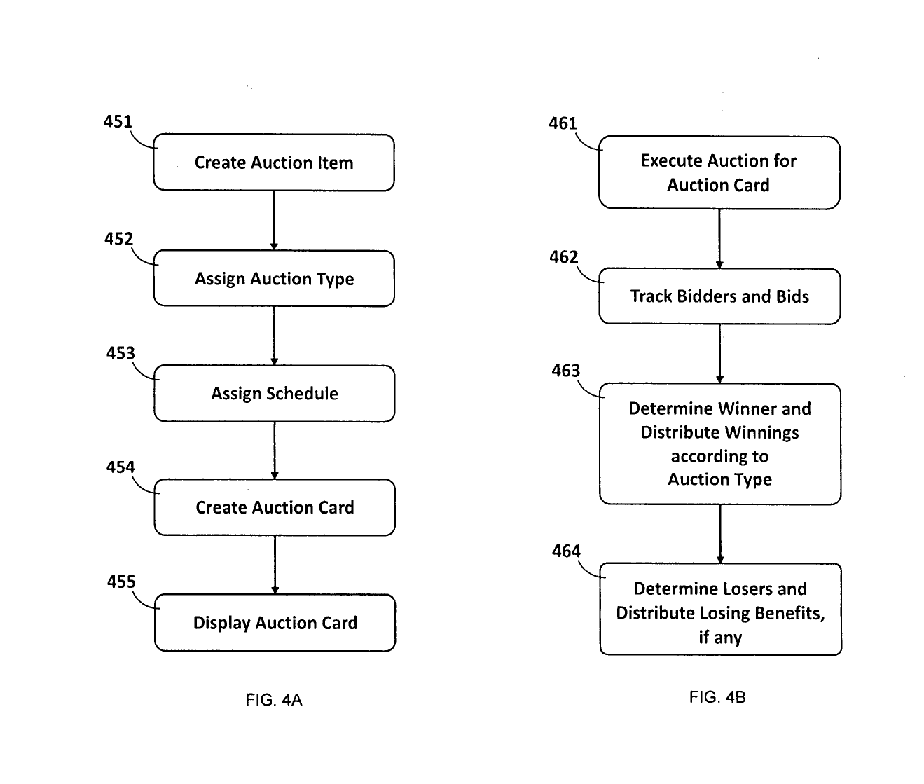

Referring to FIG. 4A, a general method of operation of the auction server prior to the start of an auction event is shown. At step 451, the auction server creates an auction item by receiving, from a client system of a sponsor or an owner, the set of detailed information. At step 452, the auction server assigns an auction type to the auction item. The auction type is a set of pre-coded attributes and instructions that dictate how the card will interact with the auction page before and after the auction. At step 453, the auction server assigns a schedule for auctioning the auction item. Then, at step 454, an “auction card” for the auction item with the auction type, the schedule for auctioning and the set of detailed information is created and stored in the database server. At step 455, a representation of the “auction card” for the auction type is displayed in a placeholder position on at least one auction page in the set of auction pages according to the schedule for auctioning and using the set of detailed information for the “auction card”.

In a preferred embodiment, the auction types are: “Take Home Money” type, “Bidding Money” type, “Permit Tag” type, “Bids Back” type, “Resale” type, “Non-Resale” type, “Redeem Coupons” type and “Shares” type.

Referring to FIG. 4B, a general method of operation of the auction server during and after an auction event is shown. At step 461, an auction for an “auction card” is executed according to the set of pre-coded attributes and instructions for the “auction type” assigned to the “auction card”. The set of pre-coded instructions generally carry out steps 462 through 464.

At step 462, the auction server tracks and records bids for the auction card for all bidders. At step 463, when the auction countdown timer for the auction card has expired, the auction server determines a winning bidder for the “auction card” and assigns the won item to a winning bidder account. At step 464, a set of losing bidders is also determined for the auction card and a set of losing benefits assigned to a set of losing bidders accounts.

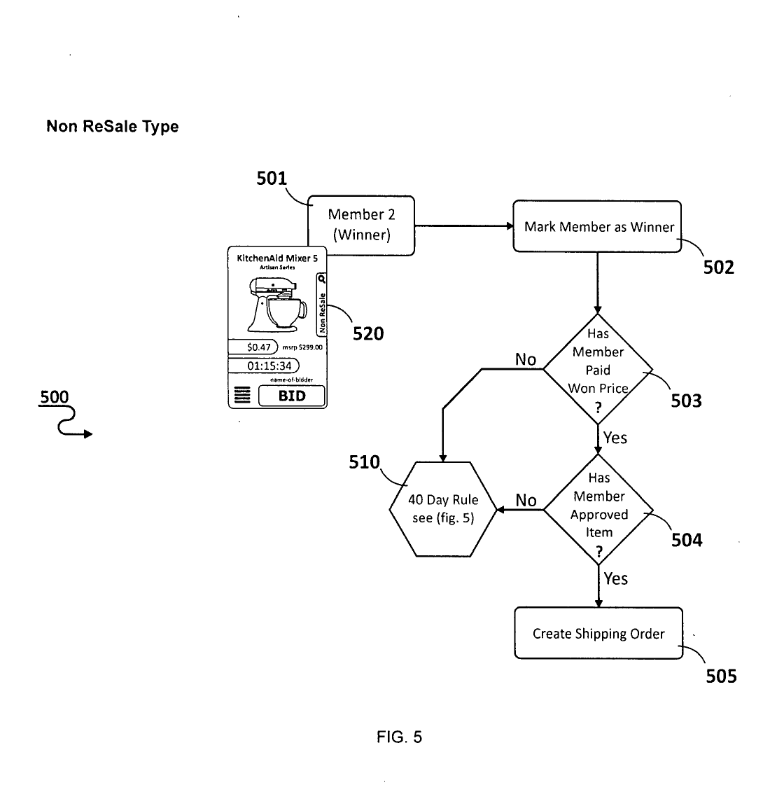

Referring to FIG. 5, a “Non-Resale” auction process 500 is described. At step 501, a member bids and wins a “Non-Resale” type auction card 520 as a won item at a won price. At step 502, the member is marked in the database as the winner. At step 503, the auction server determines if the member has recently paid the won price. If the won price has been paid, then at step 504, the auction server presents the member with an approval message and waits for the member to approve delivery of the won item. At step 505, the auction server creates a shipping order which initiates a shipping of the won item to the member.

If at step 503, the member has not paid the won price for the won item, then 40-day rule 510 is checked. Also, at step 504, if the member has not yet approved the delivery of the won item, then 40-day rule 510 is checked. According to 40-day rule 510, the member has up to 40 days to pay the won price and approve the item for delivery or else the won item is resold in a new auction.

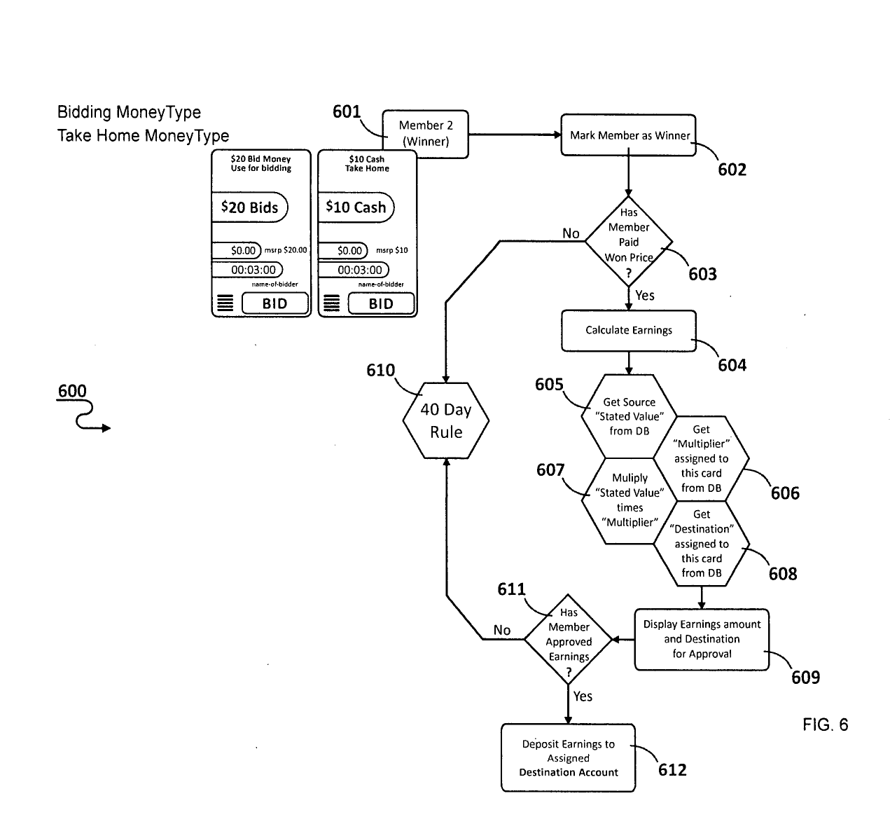

Referring to FIG. 6, a method 600 for determining and depositing earnings into a member account is shown. In a preferred embodiment, a member is assigned a member account to which monetary deposits can be made, for example, by a credit card or by a funds transfer from an actual bank account. All money in the account can be used to make bids on auction cards.

Some auction related deposits are designated as “Take Home Money” which is money that is withdrawable as cash from the member account. “Take Home Money” designation is a permission to withdraw money from a member account. A member may make a cash withdrawal of deposits designated as “Take Home Money” provided their balance of “Take Home Money” in their member account is greater than the amount being withdrawn. The withdrawal can be accomplished by methods known in the art, for example, a credit is made to a credit card or a funds transfer is made to an actual bank account.

Some auction related deposits are designated as “Bidding Money” which is money that is withdrawable for bids on auction cards from the member account. “Bidding Money” designation is a restriction to withdraw money from a member account for make bids only. “Bidding Money” is not withrdawable as cash. However, a member may withdraw “Take Home Money” for bids by redesignating “Take Home Money” as “Bidding Money”. A member may make a bid withdrawal of deposits designated as “Bidding Money” provided their balance of their “Bidding Money” in their member account is greater than the amount being withdrawn.

When a member bids on an auction card, the member account is decremented by a predefined amount, specified by the auction card or by the auction page on which the auction card appears. If the member account has a balance of zero or is less than the cost of a bid, then the member cannot bid in an auction.

At step 601, a member bids and wins a card that represents either a “Take Home Money” auction type or a “Bidding Money” auction type. At step 602, the member is marked as the winner of the card in the database for a won price. At step 603, the auction server determines if the member has recently paid the won price. If the won price has been paid, then at step 604, an earnings amount is calculated for the card. The earnings amount is calculated in steps 605, 606 and 607. At step 605, a source stated value of the card is retrieved from the database. At step 606, a multiplier is retrieved from the database for the card. At step 607, the earnings amount is determined by multiplying the source stated value by the multiplier. At step 608, a destination assigned to the auction card is retrieved from the database.

In the preferred embodiment, the destination includes the member account number and a permission tag. If the member wins an auction card of the “Take Home Money” auction type, then the permission tag signals the accounting server to designate the earnings amount to be “Take Home Money”. If the member wins an auction card of the “Bidding Money” auction type, then the permission tag signals the accounting server to designate the earnings amount as “Bidding Money”.

At step 609, the earnings amount and destination is displayed for approval and at step 611, the auction server waits for an approval from the member. If at step 611, approval is granted, then step 612 is performed, which deposits the earnings amount into the destination.

If at step 603, the member has not paid the won price for the card, then 40-day rule 610 is checked. Also, at step 611, if the member has not yet approved the earnings amount and the destination, then 40-day rule 610 is checked. According to 40-day rule 610, the member has up to 40 days to pay the won price, approve the earnings amount and approve the destination or else the card is resold in a new auction and the member forfeits the earnings amount.

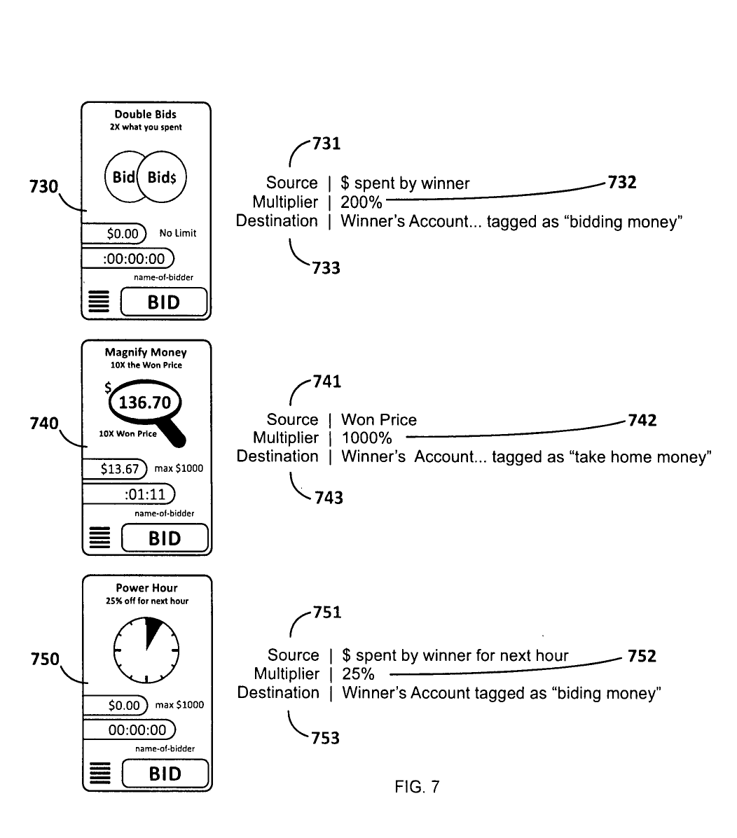

Referring to FIG. 7, three examples of auction cards are shown with detailed information relating to method 600. A “double bids” card 730, which is a “Bidding Money” auction type card, includes a source 731, a multiplier 732 of 200% and a destination 733 of a winner's member account. Source 731 is the amount of bids spent by the winner of the “double bids” card. For example, if the winner used a total of 50 bids to win “double bids” card 730 having a value of $5, then the earnings amount for winning the “double bids” card 730 is 100 bids or $10 which is deposited into the winner's member account and designated as “Bidding Money”.

A “magnify money” card 740, which is a “Take Home Money” type card, includes a source 741, a multiplier 742 of 1000% (10×) and a destination 743 of a winner's member account. Source 741 is the won price of “magnify money” card 740. For example, if the winner has spent $2.00 to pay for “magnify money” card 740, then the earnings amount for winning is $20.00 ($2 times 10) which is deposited into the winner's member account and designated as “Take Home Money”.

A “Power Hour” card 750, which is a “Bidding Money” type card, includes a source 751, a multiplier 752 of 25% and a destination 753 of a winner's account tagged as “Bidding Money”. Source 751 is the amount of bids spent by the winner for a predetermined time. The pre-determined time is assigned to the “Power Hour” card 750 prior to the auction. In the example, the predetermined time is one hour, but other card instances may have other predetermined times. For example, a winner places a total of 480 bids at a cost of one penny per bid within one hour after winning the “Power Hour” card. Then, the earnings amount for winning the “Power Hour” card 750 is 120 bids (25% ×480) or $1.20 ($0.01×120) which is deposited into the winner's member account and designated as “Bidding Money”.

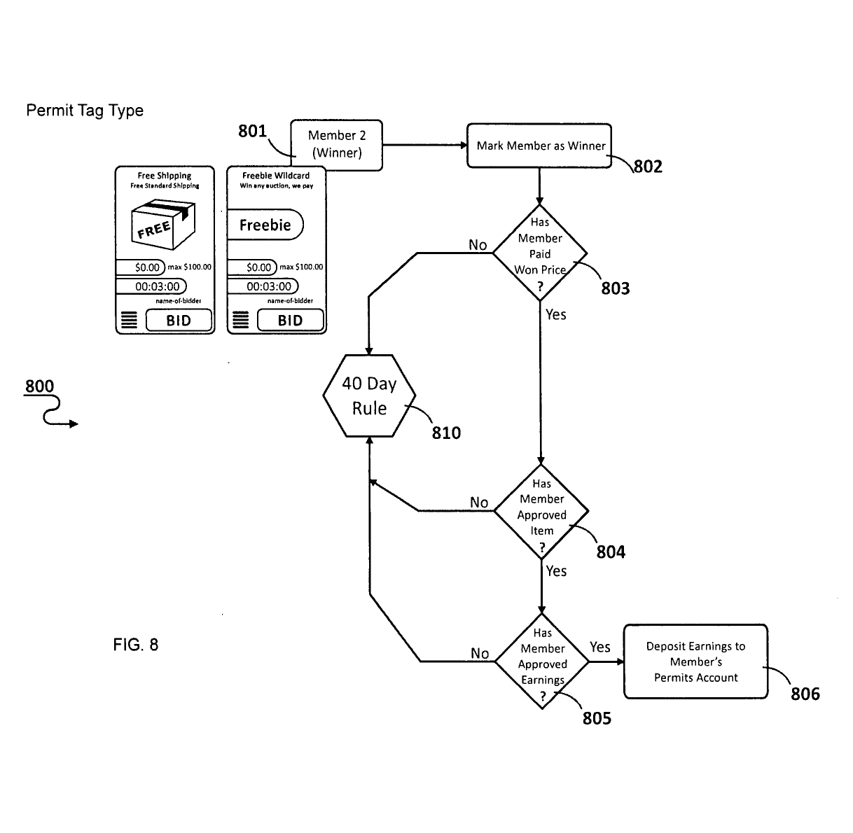

Referring to FIG. 8, a “Permit Tag” auction process 800 is described. At step 801, a member bids and wins a permit tag at a won price. At step 802, the member is marked in the database as the winner. At step 803, the auction server determines if the member has recently paid the won price. If the won price has been paid, then at step 804, the auction server presents the member with an approval message and waits for the member to approve delivery of the permit tag, based on a 40-day rule 810. If delivery of the permit tag is approved, then at step 805, the auction server presents the member with another approval message and waits for the member to approve earnings of the permit tag, based on 40-day rule 810. At step 806, the auction server deposits the permit tag into the members permit tag account. Permit tags are required to initiate a “ReSale” auction.

If at step 803, the member has not paid the won price for the permit tag, then 40-day rule 810 is checked. According to 40-day rule 810, the member has up to 40 days to pay the won price, approve the permit tag for delivery and approve the earnings or else the permit tag is resold in a new auction or the earnings are forfeited.

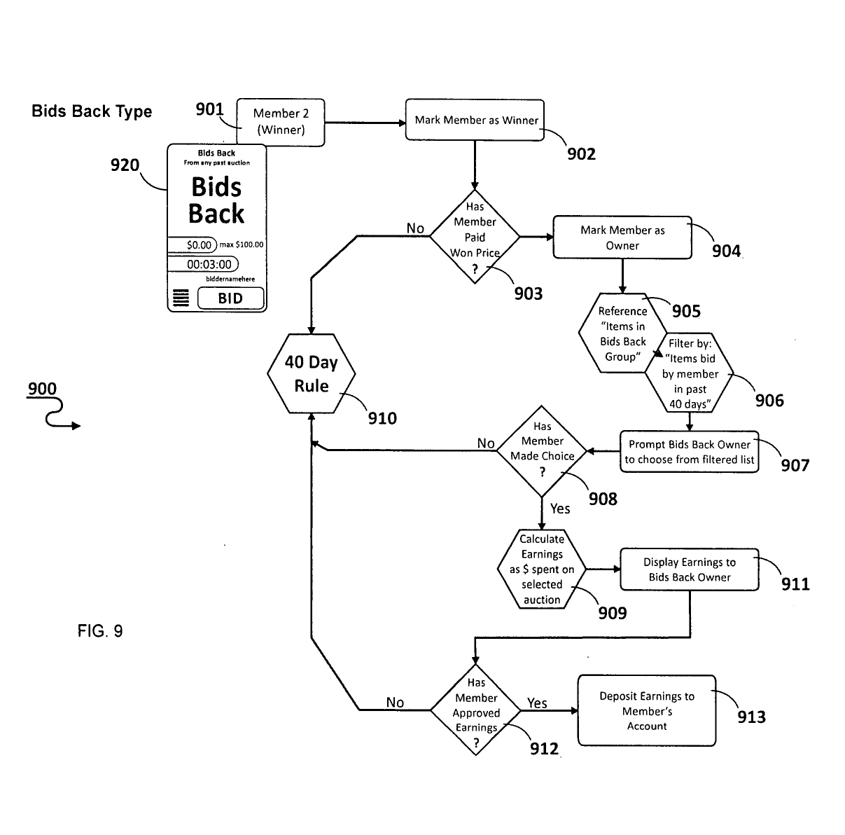

Referring to FIG. 9, a “Bids Back” auction process 900 is described. At step 901, a member bids and wins a “Bids Back” card 920 at a won price. At step 902, the member is marked in the database as the winner. At step 903, the auction server determines if the member has recently paid the won price. If the won price has been paid, then at step 904, the auction server marks the member as a “Bids Back” owner of a “Bids Back” group identified in the “Bids Back” card. At step 905, a set of previous auctions in the “Bids Back” group are identified. At step 906, a filtered set of items are filtered from the set of items where the filter determines a previous auction from the set of previous auctions bid by the member over a previous time period, for example, the last 40 days. At step 907, the auction server prompts the member to choose a single item from the filtered set of items. At step 908, the auction server determines if the member has chosen the single item. If the member has chosen the single item, then at step 909, earnings for the single item are calculated as the total number of bids spent by the member on the single item during the previous auction. At step 911, the earnings are displayed for the member equal to the number of bids spent during the previous auction. At step 912, the auction server presents the member with an approval message and waits for the member to approve the earnings. At step 913, once the earnings are approved, the auction server deposits the number of bids spent for the single item during the previous auction as “Bid Money” into the member account.

If at step 903, the member has not paid the won price for the “Bids Back” card, then 40-day rule 910 is checked. If at step 908, the member has not yet made a chose from the filtered set of items, then the 40-day rule is checked. Also, at step 912, if the member has not yet approved the earnings, then the 40-day rule is checked. According to 40-day rule 910, the member has up to 40 days to pay the won price, choose a single item from the filtered set of items and approve the earnings or else the “Bids Back” card is resold in a new auction.

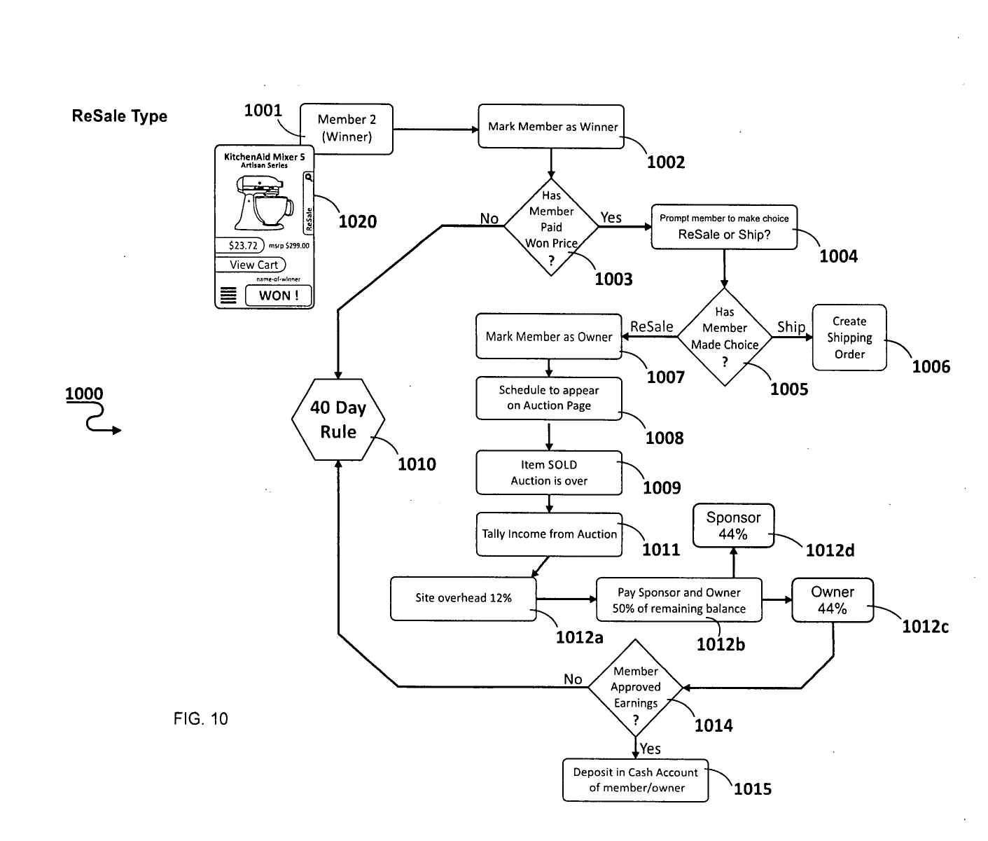

Referring to FIG. 10, a “Resale” auction process 1000 is described. At step 1001, a member bids and wins a “ReSale” auction card 1020 at a won price. At step 1002, the member is marked in the database as the winner. At step 1003, the auction server determines if the member has recently paid the won price. If the won price has been paid, then at step 1004, the auction server presents the member with a message to choose between resale and shipping of the resale item. At step 1005, the auction server waits for the member to choose between resale and shipping. If the member chooses shipping, then step 1006 is performed and the resale item is shipped to the member and the process 1000 ends. If the member chooses resale then the process continues at step 1007.

At step 1007, the member is marked in the database as the owner of the resale item. At step 1008, a new “Resale” auction is created for the resale item and scheduled to appear on the auction page. At step 1009, the resale item is sold in the new “Resale” auction. At step 1011, net income from the new “Resale” auction is determined.

In a preferred embodiment, at step 1012a, the auction server deducts a percentage of net income to cover auction site overhead. At step 1012b, the remaining balance is split between the sponsor of the resale item and the owner of the resale item. For example, at step 1012a, 12% of the net income is retained by the auction site, at step 1012c, 44% of the net income is deposited as earnings into a member account for the owner and, at step 1012d, the remaining 44% of the net income is deposited as earnings into a member account for the sponsor.

At step 1014, the auction server presents the member with an approval message and waits for the member to approve the earnings. At step 1015, the auction server deposits the earnings into the members cash account.

If at step 1003, if the member has not paid the won price for the resale item, then 40-day rule 1010 is checked. Also, at step 1014, if the member has not approved the earnings, then 40-day rule 1010 is checked. According to 40-day rule 1010, the member has up to 40 days to pay the won price or else the resale item is resold and 40 days to approve the earnings or else the earnings are forfeited.

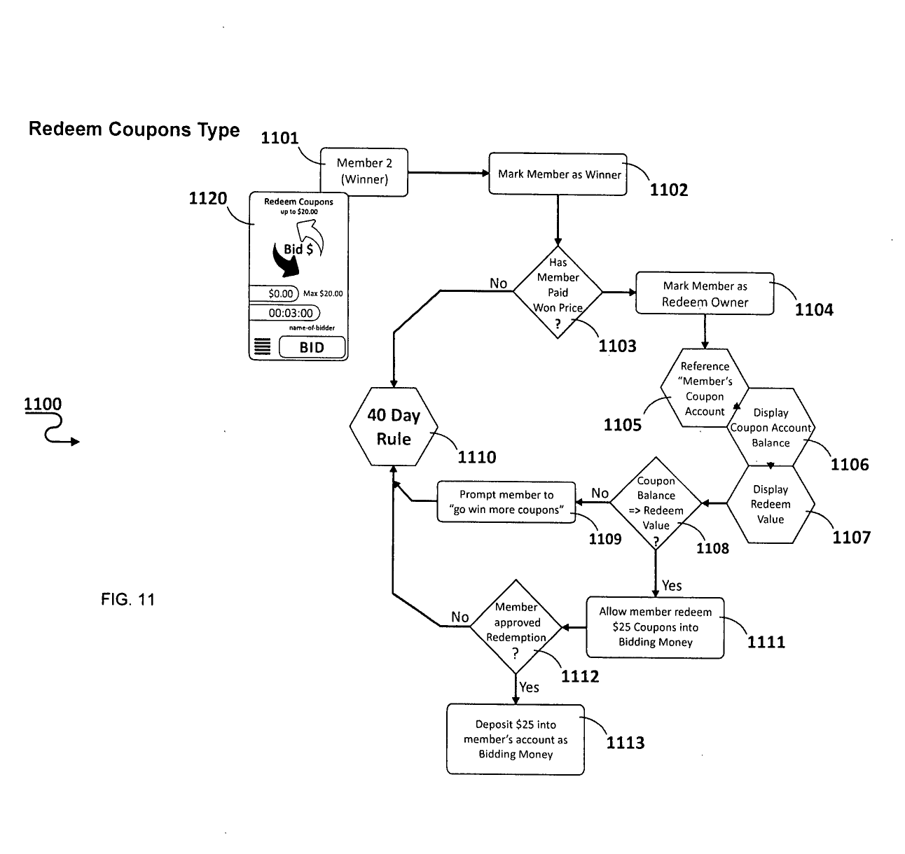

Referring to FIG. 11, a “Redeems Coupons” auction process 1100 is described. At step 1101, a member bids and wins a redeem card 1120 for redeeming coupons at a won price. At step 1102, the member is marked in the database as the winner At step 1103, the auction server determines if the member has recently paid the won price. If the won price has been paid, then at step 1104, the member is marked in the database as the redeem card owner. At step 1105, a coupon account number is looked up for the member's coupons account. At step 1106, a coupon account balance for the member's coupon account is displayed for the member. At step 1107, a coupon redeem value associated to the redeem card is displayed alongside the coupon account balance. At step 1108, the coupon account balance is compared to the coupon redeem value. If the coupon account balance is less than the coupon redeem value then, at step 1109, a message is sent to the member to “win more coupons” and 40-day rule 1110 is started where the member has 40-days to win enough coupons to make the coupon account balance greater than or equal to the coupon redeem value.

If at step 1108, the coupon account balance is greater than or equal to the coupon redeem value, then process 1100 continues at step 1111, where the auction server permits the member to redeem the coupon value into their member account. At step 1112, the auction server checks to see if member has approved redeeming the amount from step 1111. If, approved at step 1113, the amount stated on the auction card is deposited into the member account and designated as “Bidding Money”.

If at step 1103, the member has not paid the won price for the redeem card, then 40-day rule 1110 is checked. Also, at step 1112, if the member has not approved the deposit, then 40-day rule 1110 is checked. According to 40-day rule 1110, the member has up to 40 days to pay the won price or else the redeem card is resold. Also the member has up to 40 days to approve the deposit or else the earnings are forfeited.”

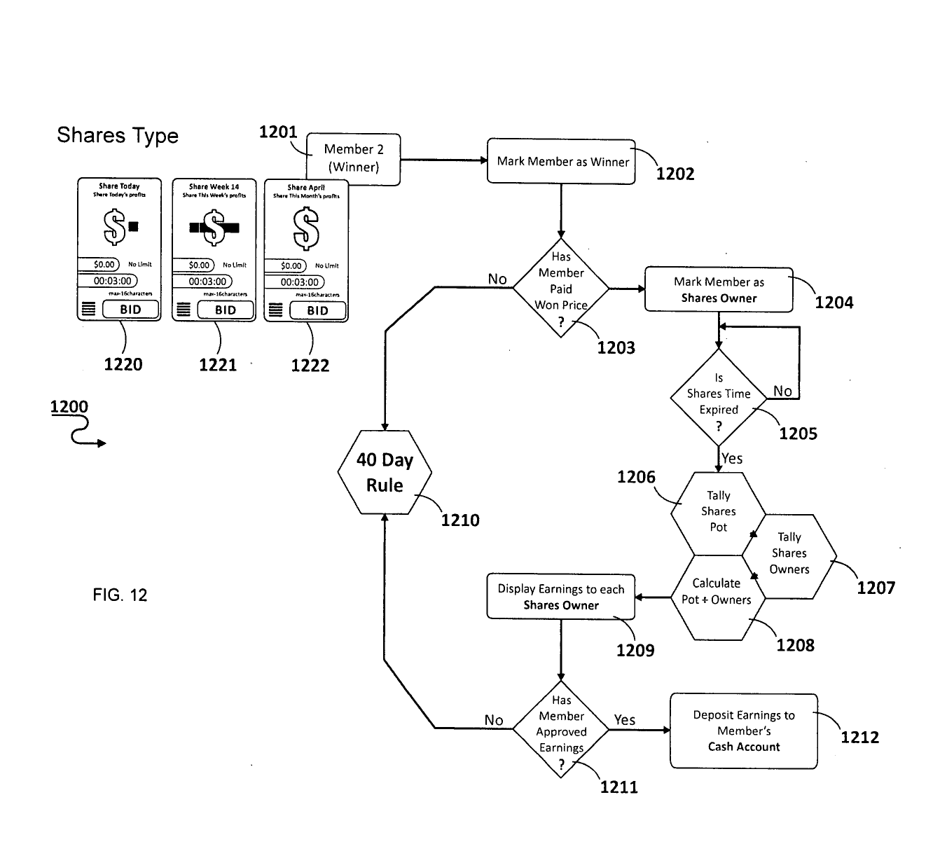

Referring to FIG. 12, a “Shares” auction process 1200 is described. At step 1201, a member bids and wins a shares card at a won price. At step 1202, the member is marked in the database as the winner. At step 1203, the auction server determines if the member has recently paid the won price. If the won price has been paid, then at step 1204, the member is marked in the database as a shares owner. Shares represent an ownership in a percentage of all card auction proceeds on the auction site for a time period defined in the shares card.

For example, one percent (1%) of the gross proceeds of all auctions on the same auction page during the assigned time period for the auction page is set aside as shares earnings which are distributed to shares card owners. In the auction card examples shown in FIG. 12, the time period for a “Share Today” auction card 1220 is one day, the time period for a “Share Week” auction card 1221 is week 16 of the current year, the time period for a “Share Month” auction card 1222 is the month of April.

At step 1205, the auction server waits until the shares time period for the shares card is expired. Then at step 1206, a shares earnings is determined for the time period. For example, the shares earnings are equal to all of the card auction proceeds on the same auction page as the shares card, during the time period assigned to the auction page. At step 1207, the shares earnings for the time period is determined and a number of shares per share owner is determined.

At step 1208, the shares earnings are divided between the shares owners based on the total number of shares and the number of shares per share owner. Further to step 1208, the member's earnings of the shares earnings is determined.

At step 1209, the member's earnings of the shares earnings is displayed. At step 1211, the auction server determines if the member has approved the member's earnings of the shares earnings. If approved, then the member's earnings of the shares earnings are deposited into the member's cash account at step 1212.

If at step 1203, the member has not paid the won price for the redeem card, then 40-day rule 1210 is checked. Also, at step 1211, if the member has not approved the earnings, then 40-day rule 1210 is checked. According to 40-day rule 1210, the member has up to 40 days to pay the won price or else the member is never marked as a shares owner and the shares card is forfeited. Also the member has up to 40 days to approve the member's earnings of the shares earnings or else the member's earnings are forfeited.

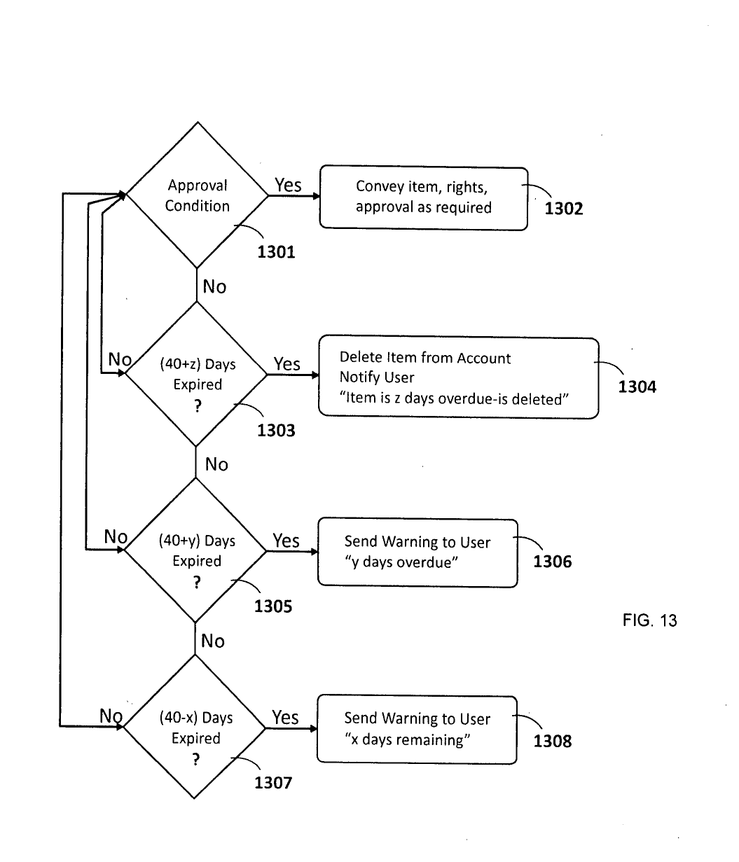

Referring to FIG. 13, a preferred embodiment method for implementing a 40-day rule is described. In many auction situations, a member needs to be approved for an auction activity or provide approval in response to an auction event and is given a time period of 40 days of elapsed time to do so. The elapsed time is measured from the auction activity or auction event. At step 1301, an approval condition is evaluated. If the approval condition is met, then at step 1302, the auction server performs a function to convey something to a member, for example, shipping an item to a bidder or approving an item for resale, conveying rights to a member benefit, or conveying approval for an auction activity. In one example, at step 1301, a potential member is approved or not approved for a cash account. At step 1302, the member is provided a cash account to use in an auction.

If, at step 1301, an approval condition is not met, then step 1303 is performed where the elapsed time is evaluated to determine if 40+z days have expired since the auction activity or auction event, and where z is a grace period in days. If the 40+z days have expired, then at step 1304, the auction server takes action to remove the benefit or item from the member's account.

If at step 1303, the approval condition is not met and the elapsed time is less than 40+z days, then at step 1305, the elapsed time is evaluated to determine if 40+y days have expired since the auction activity or auction event, where y is a late warning period in days. If the 40+y days have expired, then at step 1306, the auction server takes auction to send a warning message to the member to the effect that the member is overdue for response.

If at step 1305, the approval condition is not met and the elapsed time is less than 40+y days, then at step 1307, the elapsed time is evaluated to determine if 40+x have expired since the auction activity or auction event, where x is an early warning period in days. If the 40+x days have expired, then at step 1308, the auction server takes auction to send a warning message to the member to the effect that the member has x days left for response.

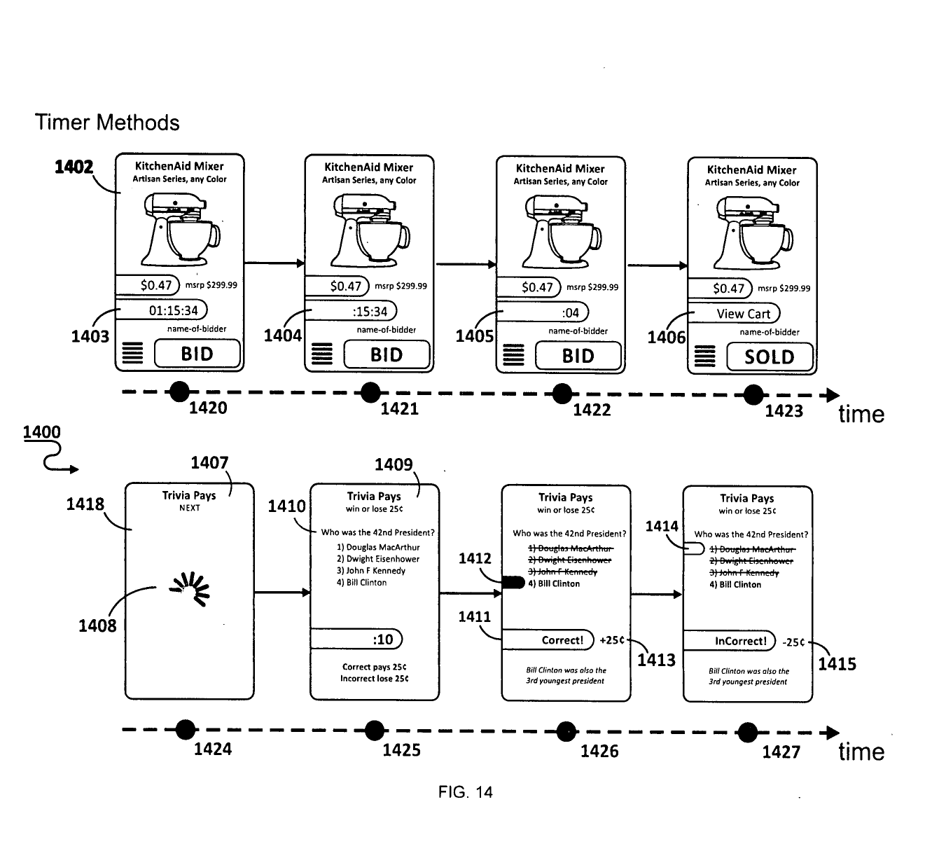

Referring to FIG. 14, a “Timers Method” is described using a time sequence of snapshots 1400 for an auction card 1402 at times 1420-1423 and for a set of placeholder cards 1418 at times 1424-1427. Throughout the times 1420-1426, the auction server is presenting auctions on many auction pages including auction card 1402. During an auction, the auction server places auction card 1402 on an auction page in a placeholder position. When the auction expires, the auction card 1402 disappears and the auction server presents the set of placeholder cards 1418 which are displayed in the placeholder position. Timers in each snapshot are displayed as “hours:minutes:seconds”.

At time 1420, auction card 1402 is displayed with timer 1403 set to display a remaining time value greater than 60 minutes, with the remaining time having a non-zero value in the “hours” section. At time 1421, timer 1404 has diminished to less than 60 minutes and the remaining time value is therefore displayed without the hours section. At time 1422, timer 1405 is further diminished to less than 1 minute and the remaining time value is displayed truncated, without the hours and minutes sections. At time 1423, timer 1406 has expired and the timer value is replaced with a label stating “Sold”. During times 1420-1423 bids are received by the auction server and tallied.

After auction card 1402 has expired, set of placeholder cards 1418 are displayed in the placeholder position while the auction server waits to display a next auction card at a pre-determined assigned time. At time 1424, placeholder card 1407 is displayed with the interim timer, 1408 and a message. Once the interim timer has expired, the next placeholder card is displayed. As an example of a placeholder activity by a placeholder card, members elect to view “While we wait” questions. At time 1425, a member sees a “While we wait” question card 1409 instead of a blank placeholder position on the auction page. Further, at time 1425, a question 1410 is presented to the member and an opportunity for response. At time 1426, timer 1411 expires and an answer to the question is received. If the member attempts to answer the question and answers the question correctly before timer 1411 expires then a winnings amount is earned as shown by answer 1412, where a first amount of money 1413 is deposited into the member account. If the member answers the question incorrectly, shown by answer 1414, then a second amount of money 1415 is deducted from the member's account. If the member elects not to participate, then no action is taken. The preferred embodiment of the interim timer and “While we wait” question would begin the timer at 10 seconds and either pay or deduct 25 cents from the member account as “Bidding Money”. Many different placeholder activities may be presented on the auction page which are not limited to “While we wait” questions.

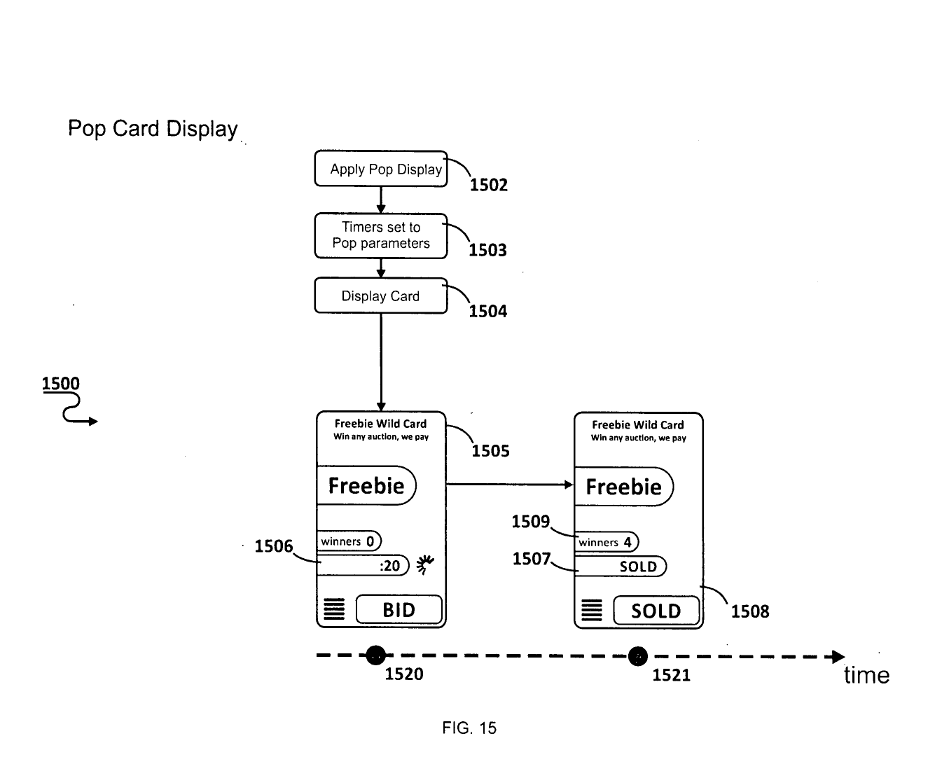

Referring to FIG. 15, the “Pop Card Display” auction process 1500 is described. The auction server allows for any placeholder position, on any auction page to be marked for display as a pop card. At step 1502, the auction server applies a pop card display to a placeholder position. At step 1503, the parameters that create the pop card display are set including a unique background color of the card, a set of pop card rules and a timer setting. At step 1504, the unique background color of the card, the predetermined set of pop card rules and the timer setting, are displayed in a “Pop Card” in a time sequence.

An example time sequence for a “Pop Card” 1505 is shown at times 1520 and 1521. At time 1520, timer 1506 is set to an initial time period (e.g. 20 seconds) and the “Pop Card” 1505 is displayed with a black background so it is deliberately set apart from the other auction cards on the auction page. The unique background color is intentional so that the “Pop Card” can be quickly noticed before timer 1506 expires. The timer for a “Pop Card” is not programmed to reset when a bid is made. In a preferred embodiment, multiple winners of a “Pop Card” are permitted and maximum number of bidders is set according to the set of pop card rules. For example, when the timer expires to zero for “Pop Card” 1505, then the “Pop Card” displays “sold” message 1507 for the timer, displays the pop card rule 1508 that every tenth bidder wins the auction item, and further displays the pop card rule 1509 that the maximum number of bidders is set to four.

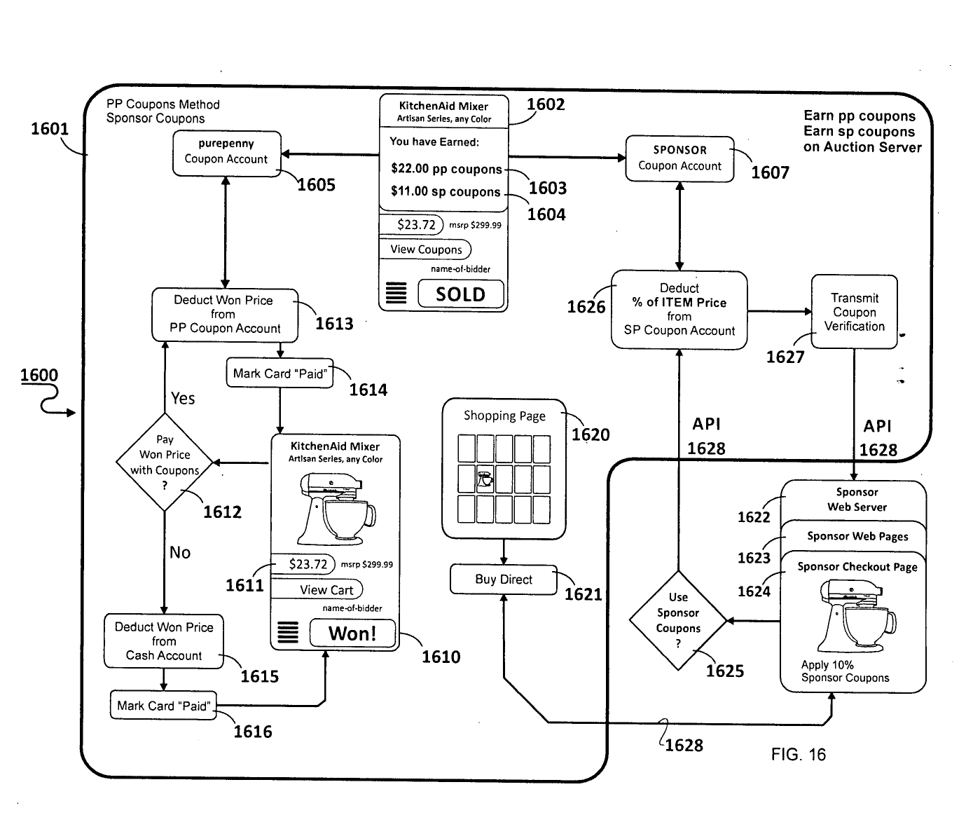

Referring to FIG. 16, an “Earn Coupons” auction process 1600 is described. Generally at step 1601, a set of auctions are performed by the auction server on multiple auction pages. At step 1602, a result of an auction is displayed where the member did not win the auction card for the auction.

According to the method 1600, when a member does not win an auction they are issued coupon money of two types; auction coupon money, hereafter referred to as “pp coupons”, and sponsor coupon money, hereafter referred to as “sp coupons”. “pp coupons” are funded and redeemable on the auction website, “sp coupons” are funded and redeemable on a sponsor website. In step 1602, the value 1603 of the “pp coupons” and the value 1604 of the “sp coupons” is derived from a percentage of the money the member spent attempting to win the auction. For example, value 1603 of the “pp coupons” represents 100% of the member spent money and value 1604 of the “sp coupons” represents 50% of the member spent money, where the sponsor percentage is pre-elected by the sponsor.

At step 1605, the auction coupon money is deposited into a member “pp coupon” account, where it remains until the member redeems it in ways provided by the auction website. At step 1607, the sponsor coupon money is deposited into a member “sp coupon” account, where it remains until the member redeems it in ways provided by the sponsor website. The member “pp coupon” and “sp coupon” accounts are separate and distinct from a regular member account that holds “Take Home Money” and “Bid Money”.

At step 1610, a second auction has been won by the member for a won auction card. At step 1611, the “Won Price” is displayed in the won auction card. In a preferred embodiment, at step 1612, a member has the choice to pay the won price by redeeming “pp coupon” money. If the member elects to pay with “pp coupon” money, then at step 1613, the money is deducted from the member “pp coupon” account, and at step 1614, the won auction card is marked as paid. If the member elects not to pay with “pp coupon” money, then at step 1615, the won price amount is deducted from the regular member account, and the auction card is marked as paid, at 1616.

According to method 1600, there are two processes for a member to redeem “sp coupons”. The first method is from the sponsor website, the second method is to redeem the “sp coupons” from the auction website on a “shopping page” of the auction website. At step 1620, the “Shopping Page” is displayed by the auction website where the “shopping page” is programmed to interact with multiple sponsor websites. On the “shopping page” auctions are displayed for purchase of items through an auction. At step 1621, a member is presented with an option to “Buy Direct” from a sponsor, where items can be purchased from a sponsor without participating in an auction. At step 1628, an auction API is activated between the auction server and a sponsor web server.

In a first embodiment, when a member elects to “Buy Direct”, an emulation of the sponsor site pages is displayed on the auction website, at step 1622, by coordinating with the sponsor webserver, at step 1623, by retrieving data from sponsor webpages, and at step 1624, by displaying the sponsor check out page.

In a second embodiment, the member elects to visit sponsor webpages outside of the auction server. The sponsor webserver utilizes the auction API to accomplish purchases on behalf of the member.

At step 1625, the member is offered the choice to pay a portion of the price by redeeming “sp coupons” from the “sp coupon” account. If the member elects to redeem sponsor coupons, then at step 1626, the item price is deducted from the member “sp coupon” account based on an exchange rate. At step 1627, a verification is transmitted to the sponsor checkout page. The exchange rate is a pre-determined percentage of a sponsor price unit for a unit of “sp coupon” value. Sponsors have control of the amount of “sp coupons” that may be redeemed for any item represented by negotiating the exchange rate.

Although this disclosure has described and illustrated particular embodiments by example, it is to be understood that the invention is not restricted to the particular embodiments. For example, the flow diagrams are not meant to be limiting with respect to the order of operations performed. The foregoing description is not intended to be exhaustive or limiting with respect to the form disclosed. Many modifications and variations of the particular embodiments are possible in light of the above teachings.

1. A computer system for managing an auction comprising:
a server;
a set of auction cards stored on the server;
the set of auction cards organizing a set of information related to a set of auctions;
a set of instructions, stored on the server, that when executed cause the server to:
receive a set of deposits into a set of client accounts;
conduct a set of auctions to determine a set of proceeds; and,
distribute the set of proceeds into the set of client accounts according to the set of information.

2. The computer system of claim 1 wherein an auction card in the set of auction cards comprises:
an auction price value;
a time indicator value;
a bid value; and,
wherein the set of instructions, when executed, further causes the server to:
increment the auction price value;
increment the time value; and,
increment the bid value.

3. The computer system of claim 1 wherein the set of instructions, when executed, further causes the server to: create an auction item;
assign an auction category to the auction item;
create an auction card of the set of auction cards for the auction item; and,
display the auction card of the set of auction cards.

4. The computer system of claim 3 wherein the set of instructions, when executed, further causes the server to:
store a schedule for the auction card; and,
execute an auction based on the schedule.

5. The computer system of claim 4 wherein the set of instructions, when executed, further causes the server to:
display an auction page; and
display the set of auction cards in the auction page based on the schedule.

6. The computer system of claim 3 wherein the set of instructions, when executed, further causes the server to:
accept a set of bids from a set of auction bidder clients;
track the set of bids;
increment the time indicator value; and,
determine a winner of the auction card of the set of auction cards based on the set of bids and the time indicator value.

7. The computer system of claim 6 wherein the set of instructions, when executed, further causes the server to:
decrement a set of bidding accounts;
determine a winner of the auction card of the set of auction cards;
determine an award; and,
distribute the award to the winner.

8. The computer system of claim 6 wherein the set of instructions, when executed, further causes the server to:
determine a losing bidder from the set of bids and the time value; and,
distribute a set of losing benefits to the set of losing bidders.

9. The computer system of claim 8 wherein the set of losing benefits includes a coupon redeemable for a set of future bids.

10. The computer system of claim 6 further comprising:
a client system connected to the server; and,
wherein the set of instructions, when executed, further causes the server to:
receive a permit tag from a permit tag account; and,
accept a bid from the client system associated with the permit tag.

11. A method for conducting an auction between a set of bidders, comprising:
providing an auction server;
defining a set of auction cards;
defining a set of auction parameters in the set of auction cards;
defining an award item in the set of parameters;
auctioning a first auction card of the set of auction cards to the set of bidders;
determining a winning bidder, from the set of bidders; and,
determining a losing bidder, from the set of bidders.

12. The method of claim 11 further comprising the steps of:
defining an owner of the first auction card, of the set of auction cards, in the set of parameters;
determining an earnings amount for the first auction card of the set of auction cards; and,
distributing the earnings amount to the owner.

13. The method of claim 11 further comprising the steps of:
auctioning a subset of auction cards of the set of auction cards during a fixed period time;
determining a set of earnings associated with the subset of auction cards;
dividing the set of earnings into a set of percentages;
assigning a percentage of the set of percentages to the award item.

14. The method of claim 11 further comprising:
determining a schedule for auctioning a subset of auction cards in the set of auction cards; and,
auctioning the subset of auction cards on an auction page based on the schedule.

15. The method of claim 11 further comprising the step of:
defining an auction item, a time value, and a bid value in the set of auction parameters.

16. The method of claim 11 further comprising the steps of:
distributing a coupon to the losing bidder;
providing a second auction card, of the set of auction cards;
defining a parameter in the set of parameters that allows the coupon to be redeemed for a cash amount; and,
auctioning the second auction card.

17. The method of claim 11 further comprising the steps of:
providing a set of member accounts for the set of bidders;
decrementing a set of bid amounts from the set of member accounts;
decrementing an award price from a member account for the winning bidder;
distributing a benefit to the losing bidder; and,
receiving a set of instructions regarding the award item.

18. The method of claim 17 farther comprising the steps of:
summing a number of bids spent by the winning bidder; and,
depositing a bid amount into the member account for the winning bidder based on the number of bids spent by the winning bidder.

19. The method of claim 18 further comprising the steps of:
providing a specified time period; and,
summing the number of bids spent by the winning bidder during the specified period of time.

20. The method of claim 11 further comprising the steps of:
providing a permit tag for the award item;
auctioning a second auction card of the set of auction cards;
authorizing the winning bidder to bid based on the permit tag.

21. The method of claim 11 further comprising the steps of:
defining a destination account, a source amount and a multiplier amount in the set of parameters;
multiplying the source amount by the multiplier amount to determine a deposit amount;
depositing the deposit amount in the destination account.

22. The method of claim 11 further comprising the steps of:
providing a member account for a bidder in the set of bidders;
defining a deposit amount;
depositing the deposit amount into the member account; and,
designating the deposit amount to be withdrawable as cash.

23. The method of claim 11 further comprising the steps of:
providing a member account for a bidder in the set of bidders;
defining a deposit amount;
depositing the deposit amount into the member account; and,
designating the deposit amount to be withdrawable for bids.

24. The method of claim 11 further comprising the steps of:
receiving a choice from the winning bidder related to reselling the award item;
if the choice is to ship the award item, then:
arranging for shipment of the award item to the winning bidder;
if the choice is to resell the award item, then:
marking the winning bidder as an owner of the award item;
storing a subsequent auction card on the server for resale of the award item; and,
conducting a subsequent auction to sell the subsequent auction card.

25. The method of claim 24 further comprising the steps of:
tallying an earnings from the subsequent auction; and,
distributing the earnings from the subsequent auction, according to a predefined set of proportions, to the auction organization, the sponsor and the owner.
